(19) United States
(12) Patent Application Publication
(10) Pub. No.: US 2026/0264768 A1
(43) Pub. Date: Sep. 10, 2026

(54) BRUSH BAR FOR AN EXTERIOR FACING VEHICLE COMPARTMENT

(71) Applicant: VOLVO TRUCK CORPORATION, GÖTEBORG (SE)

(72) Inventors: Luis Moura, High Point, NC (US); Mark Roberts, Winston Salem, NC (US)

(21) Appl. No.: 19/561,737

(22) Filed: Mar. 10, 2026

Related U.S. Application Data
(60) Provisional application No. 63/769,256, filed on Mar. 10, 2025.

(51) Int. Cl. B62D 25/24; B60K 1/04

(52) U.S. Cl. CPC B62D 25/24; B60K 1/04

(57) ABSTRACT

An exterior compartment for a vehicle includes a compartment body defining an interior volume, a hinge interface coupled to the compartment body, and a compartment door coupled to the hinge interface. The compartment door is movable between an open position and a closed position. The compartment door in the closed position defines an air gap at the hinge interface between the compartment door and the compartment body. The compartment further includes a brush bar coupled to at least one of the compartment body and the compartment door at the hinge interface. The brush bar at least partially covers the air gap when the compartment door is in the closed position.

### CROSS REFERENCE TO RELATED APPLICATION

This application claims the benefit of U.S. Provisional Patent Application Serial No. 63/769,256, filed on Mar. 10, 2025, the disclosure and content of which is incorporated by reference herein in its entirety.

### TECHNICAL FIELD

The disclosure relates generally to vehicle compartments. In particular aspects, the disclosure relates to a brush bar for an exterior facing vehicle compartment. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

Many commercial vehicles include exterior facing compartments for certain components, such as fuel tanks and/or energy storage systems, covered by movable fairings, which may provide aerodynamic exterior surfaces for the vehicle. In winter environments, however, freezing precipitation such as a snow and ice can accumulate between the fairings and the components in the compartment, which can interfere with the operation and accessibility of the components, and which may increase vehicle weight.

### SUMMARY

According to a first aspect of the disclosure, an exterior compartment for a vehicle includes a compartment body defining an interior volume, a hinge interface coupled to the compartment body, and a compartment door coupled to the hinge interface. The compartment door is movable between an open position and a closed position. The compartment door in the closed position defines an air gap at the hinge interface between the compartment door and the compartment body. The compartment further includes a brush bar coupled to at least one of the compartment body and the compartment door at the hinge interface. The brush bar at least partially covers the air gap when the compartment door is in the closed position. The first aspect of the disclosure may seek to address the problem of frozen precipitation accumulating within the interior volume. A technical benefit may include inhibiting the ingress of frozen precipitation in cold weather conditions while maintaining sufficient air flow within the interior volume in warm weather conditions.

Optionally in some examples, including in at least one preferred example, the brush bar is coupled to the compartment body.

Optionally in some examples, including in at least one preferred example, the brush bar is coupled to the compartment door.

Optionally in some examples, including in at least one preferred example, the brush bar comprises a plurality of flexible brush bristles.

Optionally in some examples, including in at least one preferred example, the brush bristles comprise nylon.

Optionally in some examples, including in at least one preferred example, each brush bristle of the plurality of brush bristles has a minimum diameter of 1 mm.

Optionally in some examples, including in at least one preferred example, the brush bristles are arranged in an array such that the brush bristles are separated by a maximum of 2 mm.

Optionally in some examples, including in at least one preferred example, the hinge interface is arranged at a lower end of the compartment, such that the air gap faces downward toward a road surface.

Optionally in some examples, including in at least one preferred example, movement of the compartment door between the closed position and the open position causes the brush bar to maintain contact with the other of the compartment body and the compartment door to at least partially covers the air gap when the compartment door is in the open position.

Optionally in some examples, including in at least one preferred example, movement of the compartment door between the open position and the closed position causes the brush bar to sweep across a portion of the other of the compartment body and the compartment door to remove precipitation from other of the compartment body and the compartment door.

Optionally in some examples, including in at least one preferred example, the brush bar extends away from the at least one of the compartment body and the compartment door at a downward angle of at least 30 degree with respect to a horizontal.

Optionally in some examples, including in at least one preferred example, the downward angle is at least 45 degrees with respect to the horizontal.

Optionally in some examples, including in at least one preferred example, the brush bar is arranged to obstruct frozen precipitation from entering the interior volume when the compartment door in the closed position.

Optionally in some examples, including in at least one preferred example, the brush bar is arranged to allow melted precipitation to exit the interior volume by force of gravity when the compartment door in the closed position.

Optionally in some examples, including in at least one preferred example, the brush bar is arranged to allow air to circulate between the interior volume and an exterior of the compartment when the compartment door in the closed position.

The disclosed aspects, examples (including any preferred examples), and/or accompanying examples may be suitably combined with each other as would be apparent to anyone of ordinary skill in the art. Additional features and advantages are disclosed in the following description, examples, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 is a cross sectional view of an exterior vehicle compartment for a vehicle having a brush bar for blocking the ingress of frozen precipitation, according to an embodiment.

FIG. 2 is a cross sectional view of the compartment of FIG. 1 showing the hinge interface and the compartment door in an open position.

FIG. 3 is a top view of the compartment of FIG. 1 showing the brush bar spanning the air gap to at least partially cover the air gap and block the ingress of frozen precipitation.

FIG. 4 is a cross sectional view of an alternative exterior vehicle compartment for the vehicle, according to another embodiment.

FIG. 5 is a cross sectional view of the compartment of FIG. 4 showing the hinge interface and the compartment door in an open position.

FIG. 6 is a top view of the compartment of FIG. 4 showing the brush bar spanning the air gap to at least partially cover the air gap and block the ingress of frozen precipitation.

### DETAILEDDESCRIPTION

The detailed description set forth below provides information and examples of the disclosed technology with sufficient detail to enable those skilled in the art to practice the disclosure.

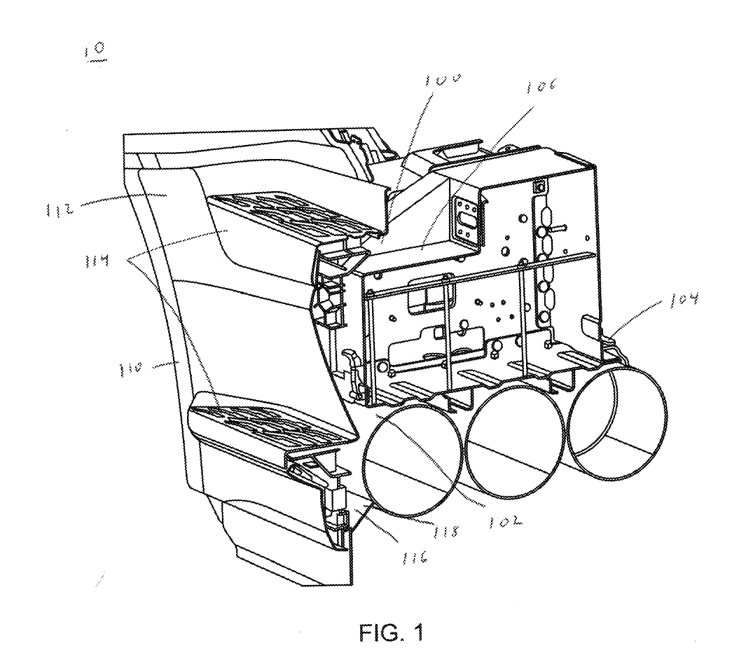

As shown by FIG. 1, an exterior compartment 100 for a vehicle 10 includes a compartment body 102 defining an interior volume. The compartment body 102 may be coupled to a chassis 104 of the vehicle 10. In this example, an Energy Storage System (ESS) 106 is disposed in the interior volume.

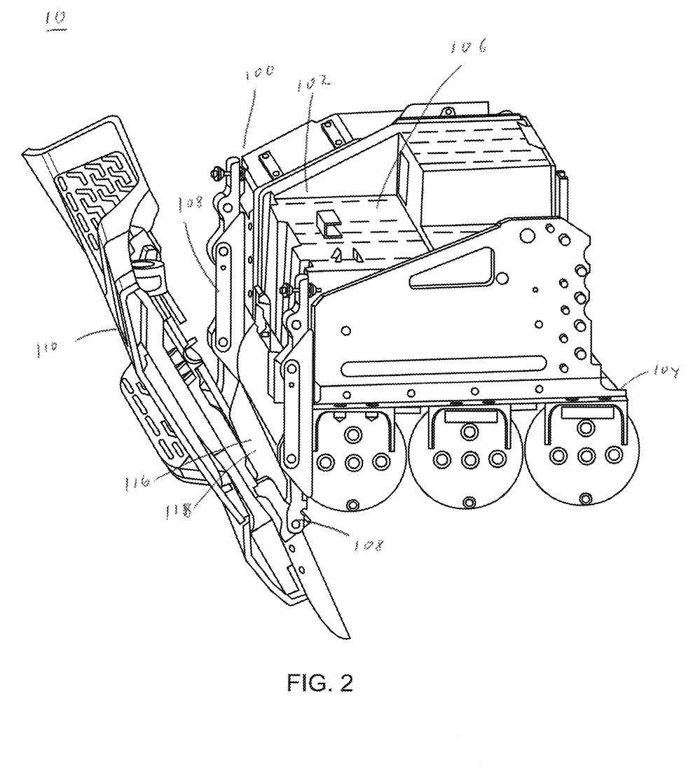

The exterior compartment may further include a hinge interface 108 (See FIG. 2) coupled to the compartment body 102, and a compartment door 110 coupled to the hinge interface 108. In this example, the compartment door 110 includes a fairing surface 112 to provide an aerodynamic surface for the vehicle 10 and a plurality of steps 114 to allow a driver and/or passenger to more easily enter or exit the vehicle cab. The compartment door 110 is movable between an open position and a closed position, e.g., to allow access to the ESS 106 in this example. As shown by FIG. 1, the compartment door 110 in the closed position defines an air gap 116 between the compartment door 110 and the compartment body 102.

The exterior compartment 100 may further include a brush bar 118 coupled to the compartment body 102 proximate the hinge interface 108, such that the brush bar 118 at least partially covers the air gap 116 when the compartment door 110 is in the closed position. It should be understood, however, that the brush bar 118 in some embodiments may be coupled to the compartment door 110, alternatively or in addition.

In many embodiments, maintaining the air gap 116, i.e., not fully enclosing the interior volume of the vehicle compartment 100, may be desirable. For example, in warm weather conditions, it may be desirable to maintain air flow around the components to prevent overheating. In some embodiments, the hinge interface 108 may be arranged arranged at a lower end of the compartment 100, such that the air gap 116 faces downward toward a road surface.

In warm weather conditions, the downward facing air gap 116 may facilitate the flow of liquid precipitation to exit the interior volume by force of gravity. However, in cold weather conditions, the air gap 116 may allow for ingress of frozen precipitation, i.e., ice and snow, in winter conditions. This may be further exacerbated by the placement of certain compartments 100 on the vehicle 10, such as behind a vehicle wheel, where the vehicle wheel produces a high pressure zone under the vehicle proximate the compartment 100, while the air gap 116 produces a low pressure zone under the compartment 100. This pressure mismatch may urge frozen precipitation from the road into the interior volume of the compartment body 102, where it may accumulate and potentially block and/or damage vehicle components, and where it may also add unnecessary weight to the vehicle 10.

By coupling the brush bar 118 to at least partially cover the air gap 116, air flow may be maintained when driving in warm weather conditions, while also acting as a barrier to frozen precipitation in cold weather conditions. The brush bar 118 may include a closely spaced array of brush bristles, e.g., separated by 1-2 mm in this example, which may be sufficiently flexible to conform to different compartment shapes with different touchpoints and shapes. Moreover, the frozen precipitation may adhere to the brush bar 118 and freeze solid in cold weather conditions, thereby partially or fully sealing the interior volume compartment body 102 from the exterior of the vehicle 10 and providing a solid barrier against the ingress of any additional frozen precipitation.

The bristles may each have a suitable cross-sectional diameter (e.g., 1 mm)and length to maintain contact with the compartment body 102 during movement of the compartment door between the closed position and the open position to at least partially cover the air gap 116 when the compartment door 110 is in the open position. In this example, the bristles are composed of nylon or another suitable material. The individual bristles may also each have a relatively small cross sectional diameter, which in turn reduces the surface area of the individual bristles and may facilitate melting of the accumulated frozen precipitation, e.g., as ambient temperatures increase and/or from heat produced by the vehicle components. It should be understood, however, that any suitable combination of cross-sectional diameter, length, spacing, and materials may be used, as desired.

In this example, the brush bar 118 is arranged to allow air to circulate between the interior volume and an exterior of the compartment 100 when the compartment door 110 in the closed position, and to obstruct frozen precipitation from entering the interior volume when the compartment door 110 in the closed position. In addition, the brush bar 118 is arranged to allow melted precipitation to exit the interior volume by force of gravity when the compartment door 110 in the closed position. For example, in this embodiment, the brush bar extends away from the compartment door 110 at a downward angle with respect to the horizontal (i.e., the road) to facilitate the flow of melted precipitation to exit the interior volume by force of gravity. In some examples, the angle may be at least 30 degrees with respect to the horizontal, at least 45 degrees with respect to the horizontal, or any other suitable angle, as desired.

FIG. 2 is a cross sectional view of the compartment 100 of FIG. 1 showing the hinge interface 108 and the compartment door 110 in an open position. In this example, moving the compartment door 110 to the open position causes the brush bristles of the brush bar 118 such that sweep across a surface of the compartment door 110, which may aid in removing frozen precipitation or other debris from the compartment 100.

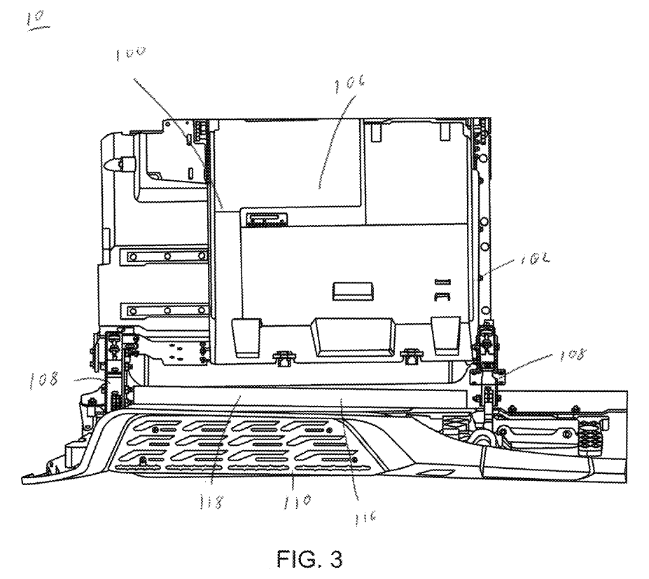

FIG. 3 is a top view of the compartment 100 showing the brush bar 118 spanning the air gap 116 to at least partially cover the air gap 116 and block the ingress of frozen precipitation.

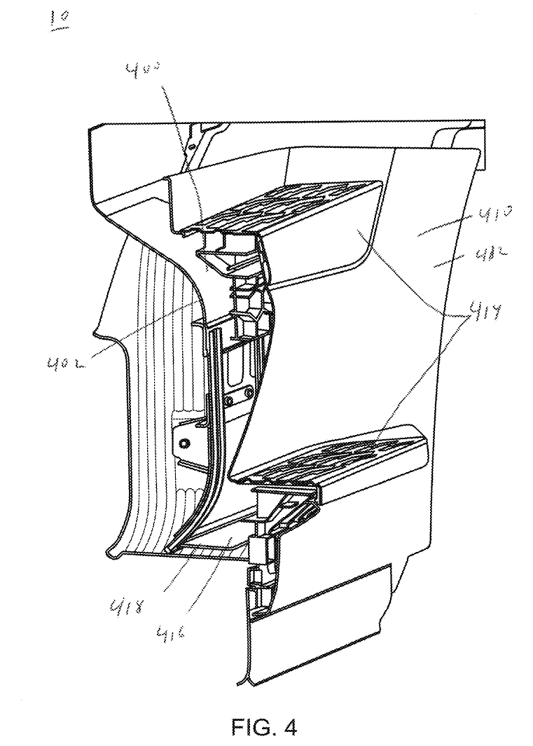

FIG. 4 is a cross sectional view of an alternative compartment 400 for the vehicle 10. In this example, the compartment door 410 includes a passenger side fairing surface 412 and steps 414 that covers a differently shaped compartment body 402 with a differently shaped interior volume and differently shaped air gap 416 between the compartment body 402 and the compartment door 410. The brush bar 418 in this example conforms to the differently shaped touch points of the compartment body to at least partially cover the air gap 416.

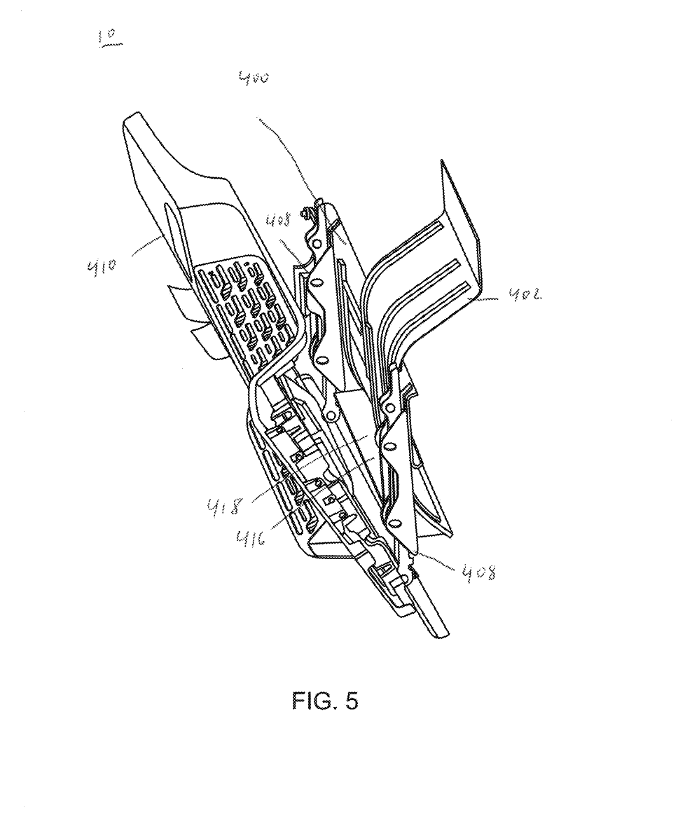

FIG. 5 is a cross sectional view of the compartment 400 of FIG. 4 showing the hinge interface 408 and the compartment door 410 in an open position.

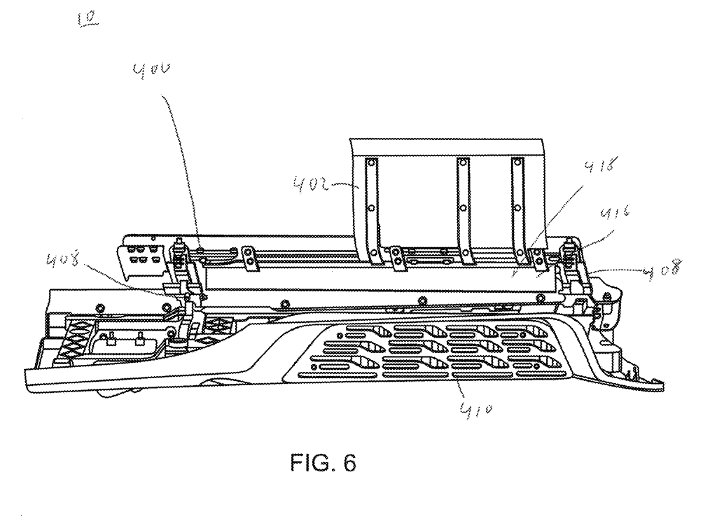

FIG. 6 is a top view of the compartment 400 showing the brush bar 418 spanning the air gap 416 to at least partially cover the air gap 416 and block the ingress of frozen precipitation.

Advantages of these and other embodiments include providing a versatile solution for many different climates without the need for replacing or modifying a configuration of the vehicle compartment. For example, a long haul drive between a warm weather climate (e.g., Texas) and a cold weather climate (e.g., Alaska) may involve drastically different climate conditions during a single trip. To address this technical problem, embodiments disclosed herein permit an exterior compartment may maintain adequate ventilation in warm weather conditions to prevent overheating, and inhibit ice and snow accumulation in the compartment in cold weather conditions without the need to reconfigure the vehicle compartment.

Additional Examples include:

Example 1. An exterior compartment for a vehicle comprising:

a compartment body defining an interior volume;

a hinge interface coupled to the compartment body;

a compartment door coupled to the hinge interface,

wherein the compartment door is movable between an open position and a closed position,

wherein the compartment door in the closed position defines an air gap at the hinge interface between the compartment door and the compartment body; and

a brush bar coupled to at least one of the compartment body and the compartment door at the hinge interface,

wherein the brush bar at least partially covers the air gap when the compartment door is in the closed position.

Example 2. The exterior compartment of example 1, wherein the brush bar is coupled to the compartment body.

Example 3. The exterior compartment of example 1, wherein the brush bar is coupled to the compartment door.

Example 4. The exterior compartment of example 1, wherein the brush bar comprises a plurality of flexible brush bristles.

Example 5. The exterior compartment of example 4, wherein the brush bristles comprise nylon.

Example 6. The exterior compartment of example 4, wherein each brush bristle of the plurality of brush bristles has a minimum diameter of 1 mm.

Example 7. The exterior compartment of example 4, wherein the brush bristles are arranged in an array such that the brush bristles are separated by a maximum of 2 mm.

Example 8. The exterior compartment of example 1, wherein the hinge interface is arranged at a lower end of the compartment, such that the air gap faces downward toward a road surface.

Example 9. The exterior compartment of example 1, wherein movement of the compartment door between the closed position and the open position causes the brush bar to maintain contact with the other of the compartment body and the compartment door to at least partially covers the air gap when the compartment door is in the open position.

Example 10. The exterior compartment of example 1, wherein movement of the compartment door between the open position and the closed position causes the brush bar to sweep across a portion of the other of the compartment body and the compartment door to remove precipitation from other of the compartment body and the compartment door.

Example 11. The exterior compartment of example 1, wherein the brush bar extends away from the at least one of the compartment body and the compartment door at a downward angle of at least 30 degree with respect to a horizontal.

Example 12. The exterior compartment of example 9, wherein the downward angle is at least 45 degrees with respect to the horizontal.

Example 13. The exterior compartment of example 1, wherein the brush bar is arranged to obstruct frozen precipitation from entering the interior volume when the compartment door in the closed position.

Example 14. The exterior compartment of example 1, wherein the brush bar is arranged to allow melted precipitation to exit the interior volume by force of gravity when the compartment door in the closed position.

Example 15. The exterior compartment of example 1, wherein the brush bar is arranged to allow air to circulate between the interior volume and an exterior of the compartment when the compartment door in the closed position.

The terminology used herein is for the purpose of describing particular aspects only and is not intended to be limiting of the disclosure. As used herein, the singular forms "a," "an," and "the" are intended to include the plural forms as well, unless the context clearly indicates otherwise. As used herein, the term "and/or" includes any and all combinations of one or more of the associated listed items. It will be further understood that the terms "comprises," "comprising," "includes," and/or "including" when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as "below" or "above" or "upper" or "lower" or "horizontal" or "vertical" may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being "connected" or "coupled" to another element, it can be directly connected or coupled to the other element, or intervening elements may be present. In contrast, when an element is referred to as being "directly connected" or "directly coupled" to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended examples. In the drawings and specification, there have been disclosed aspects for purposes of illustration only and not for purposes of limitation, the scope of the disclosure being set forth in the following examples.

What is claimed is:

1. An exterior compartment for a vehicle comprising:
a compartment body defining an interior volume;
a hinge interface coupled to the compartment body;
a compartment door coupled to the hinge interface,
wherein the compartment door is movable between an open position and a closed position,
wherein the compartment door in the closed position defines an air gap at the hinge interface between the compartment door and the compartment body; and
a brush bar coupled to at least one of the compartment body and the compartment door at the hinge interface,
wherein the brush bar at least partially covers the air gap when the compartment door is in the closed position.

2. The exterior compartment of claim 1, wherein the brush bar is coupled to the compartment body.

3. The exterior compartment of claim 1, wherein the brush bar is coupled to the compartment door.

4. The exterior compartment of claim 1, wherein the brush bar comprises a plurality of flexible brush bristles.

5. The exterior compartment of claim 4, wherein the brush bristles comprise nylon.

6. The exterior compartment of claim 4, wherein each brush bristle of the plurality of brush bristles has a minimum diameter of 1 mm.

7. The exterior compartment of claim 4, wherein the brush bristles are arranged in an array such that the brush bristles are separated by a maximum of 2 mm.

8. The exterior compartment of claim 1, wherein the hinge interface is arranged at a lower end of the compartment, such that the air gap faces downward toward a road surface.

9. The exterior compartment of claim 1, wherein movement of the compartment door between the closed position and the open position causes the brush bar to maintain contact with the other of the compartment body and the compartment door to at least partially covers the air gap when the compartment door is in the open position.

10. The exterior compartment of claim 1, wherein movement of the compartment door between the open position and the closed position causes the brush bar to sweep across a portion of the other of the compartment body and the compartment door to remove precipitation from other of the compartment body and the compartment door.

11. The exterior compartment of claim 1, wherein the brush bar extends away from the at least one of the compartment body and the compartment door at a downward angle of at least 30 degree with respect to a horizontal.

12. The exterior compartment of claim 9, wherein the downward angle is at least 45 degrees with respect to the horizontal.

13. The exterior compartment of claim 1, wherein the brush bar is arranged to obstruct frozen precipitation from entering the interior volume when the compartment door in the closed position.

14. The exterior compartment of claim 1, wherein the brush bar is arranged to allow melted precipitation to exit the interior volume by force of gravity when the compartment door in the closed position.

15. The exterior compartment of claim 1, wherein the brush bar is arranged to allow air to circulate between the interior volume and an exterior of the compartment when the compartment door in the closed position.
